(19) United States
(12) Patent Application Publication
(10) Pub. No.: US 2018/0372018 A1
(43) Pub. Date: Dec. 27, 2018

(54) FUEL INJECTION NOZZLE

(71) Applicant: Robert Bosch GmbH, Stuttgart (DE)

(72) Inventors: Gerhard SUENDERHAUF, Tiefenbronn (DE); Mark-Florian FELLMANN, Stuttgart-Feuerbac (DE); Ulrich MAY, Rutesheim (DE); Werner TESCHNER, Stuttgart (DE); Wilhelm CHRIST, Ludwigsburg (DE)

(21) Appl. No.: 16/063,564

(22) PCT Filed: Nov. 15, 2016
(86) PCT No.: PCT/EP2016/077701

§ 371 Date: Jun. 18, 2018

(30) Foreign Application Priority Data
Dec. 17, 2015 (DE) 10 2015 225 733.9

(51) Int. Cl. F02D 41/38; F02M 61/16; F02M 61/18; F02M 65/00

(52) U.S. Cl. CPC F02D 41/38; F02M 61/166; F02D 2041/2055; F02M 65/005; F02M 61/18

(57) ABSTRACT

The invention relates to a fuel injection nozzle comprising a nozzle element (1) in which a pressure chamber (2) is formed which can be filled with pressurized fuel and in which a nozzle needle (3) is arranged in a longitudinally movable manner, a sealing surface (7) of said nozzle needle interacting with a nozzle seat (8) in order to open and close at least one injection opening (11). The nozzle needle (3) has a guide section (5) by means of which the nozzle needle is guided in a guide region (6) of the pressure chamber (2) in a radial direction. The nozzle needle (3) has a coating (20) at least in the region of the sealing surface (7), and the coating is a DLC layer (DLC=diamond-like carbon). In the open position, the nozzle needle (3) is electrically insulated from the nozzle element (1).

### BACKGROUND OF THE INVENTION

The invention relates to a fuel injection nozzle of the kind that is preferably used to inject fuel directly into a combustion chamber of an internal combustion engine.

An injection nozzle for injecting liquid fuel at high pressure into a combustion chamber of an internal combustion engine is known from the prior art, e.g. from WO 2006/117266 A1. A fuel injection nozzle of this kind has a nozzle body, in which there is formed a pressure chamber that can be filled with fuel at high pressure. Arranged in a longitudinally movable manner in the pressure chamber is a nozzle needle, which interacts with a nozzle seat to open and close at least one injection opening. During this process, contact occurs between the nozzle needle and the nozzle seat in order to form a sealing seat and to interrupt the fuel flow to the injection openings when required. The stress between the nozzle needle and the nozzle seat is essentially an impact stress, but a sliding stress may be superimposed on this owing to the high pressure in the nozzle body and the associated slight deformation. This leads to high mechanical stress on the nozzle needle and on the nozzle seat, with the result that wear may occur there and possibly impair the operation of the fuel injection nozzle over the life thereof. To avoid excessive wear between the nozzle needle and the nozzle seat, WO 2006/117266 A1 discloses providing the sealing surface of the nozzle needle with a “DLC layer” (diamond-like carbon), which is particularly hard and suitable for reducing the wear in this region.

In modern fuel injection systems, the movement of the nozzle needle and hence the time and duration of injection is controlled by an electric actuator, e.g. by a piezoelectric actuator or an electromagnet. In this case, the nozzle needle can either be moved directly, with the corresponding electric actuator acting directly on the nozzle needle—optionally via a mechanical or hydraulic coupler—or with the nozzle needle being moved by servo hydraulic means. In this case, there is a hydraulic control chamber which exerts a hydraulic closing force on the nozzle needle. When the pressure in this control chamber is lowered, the nozzle needle is moved by the hydraulic forces in the pressure chamber, and it can be conveyed back into its closed position by raising the pressure in the control chamber again. For the satisfactory functioning of the internal combustion engine, it is essential that the time and duration of fuel injection should be matched precisely to the desired operating state. The electric actuator is therefore controlled by means of a control unit, which can take into account various input signals, e.g. signals from sensors, and thus determines the optimum injection point.

The control unit controls the control current of the electric actuator, which moves the nozzle needle directly or indirectly, but does not receive any feedback on the actual movement of the nozzle needle, i.e. the beginning and end of injection. However, this is advantageous for precise control of injection since there is a time delay between the electric signal of the electric actuator and the actual movement of the nozzle needle, both during opening and during closing of the latter. Here, a reliable electric signal indicating the actual movement of the nozzle needle is an electric contact between the nozzle needle and the nozzle seat. This can be achieved by providing both the nozzle needle and the nozzle body with an electric contact, wherein a voltage is applied between both electric contacts. If contact occurs between the nozzle needle and the nozzle body at the nozzle seat, an electric current flows, whereas if the nozzle needle has risen from the nozzle seat, this current is interrupted. Of course, a prerequisite for this is that an electric connection between the nozzle needle and the nozzle body takes place exclusively at the nozzle seat. However, a coating comprising a DLC layer on the nozzle seat acts as an electric insulator, and therefore this detection mechanism cannot readily be applied to the movement of the nozzle needle.

### SUMMARY OF THE INVENTION

One significant point of the present invention is the insight that the electrical properties of a DLC layer change under a high pressure; if the nozzle needle coated at its tip with a DLC layer is pressed against a nozzle seat by the pressure in a control chamber, the DLC layer becomes electrically conductive, and therefore the electrical resistance between the nozzle needle and the nozzle body can be used as an indicator of the landing of the nozzle needle on the nozzle seat—despite the DLC layer between them. To achieve this, at least the region of the sealing surface on the nozzle needle is provided with a DLC layer, wherein the nozzle needle is insulated electrically with respect to the nozzle body in the open position of the nozzle needle. It is thereby possible to exploit the effect that the DLC layer becomes electrically conductive under pressure and therefore that a clear electric signal can be picked off between the nozzle needle and the nozzle body, indicating the closed position of the nozzle needle.

It is advantageous if electric contact can be made both with the nozzle needle and the nozzle body, thus allowing an electric voltage to be applied between the nozzle needle and the nozzle body. For this purpose, the nozzle needle advantageously has an electric contact, as does the nozzle body. Provision can also be made for the nozzle body to be connected to a ground, with the result that one electric contact with the nozzle needle is sufficient and the second electric contact can be made via the ground.

In another advantageous embodiment, the nozzle needle is guided in a guide section of the nozzle body and is coated with a DLC layer in this region too. Since the DLC layer has an electrically insulating effect without a correspondingly high mechanical pressure load, it can also be used in the guide section of the nozzle needle in order to reduce wear there without the occurrence there of an unwanted electric contact between the nozzle needle and the nozzle body. In this way, it is also advantageously possible to coat the entire surface of the nozzle needle with a DLC layer, this being advantageous in terms of costs, particularly in the case of methods in which the nozzle needles are coated in bulk since there is no need to cover parts of the nozzle needles to prevent the formation of a coating in some regions of the nozzle needles.

In a method according to the invention for operating an injection nozzle, an electric voltage is applied between the nozzle needle and the nozzle body, and the current intensity of the current flowing between the nozzle needle and the nozzle body is simultaneously measured. From these two values, it is possible to determine an electrical resistance, which can advantageously be used as an input variable for the control of injection by the fuel injection valve.

### BRIEF DESCRIPTION OF THE DRAWINGS

A fuel injection nozzle according to the invention is illustrated in the drawing, in which:

FIG. 1 shows a fuel injection nozzle according to the invention in longitudinal section,

FIG. 1a shows the detail, denoted by A, from FIG. 1 in section, and

FIG. 2a shows the transfer resistance between the nozzle needle and the nozzle body with respect to time during an injection process, and

FIG. 2b shows the transfer resistance between the nozzle needle and the nozzle body with respect to time during an injection process when the nozzle needle does not have a maximum stroke limited by a mechanical stroke stop but is in “ballistic mode”.

### DETAILED DESCRIPTION

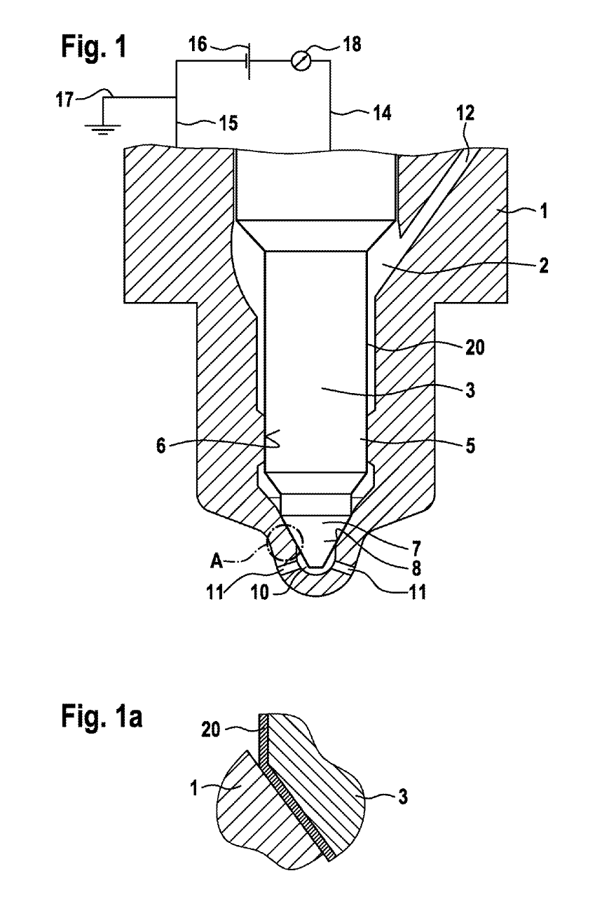

A fuel injection nozzle according to the invention is shown in longitudinal section in FIG. 1 of the drawing. The fuel injection nozzle has a nozzle body 1, in which is formed a pressure chamber 2, which can be filled with fuel at high pressure via a high-pressure hole 12 formed in the nozzle body 1. Arranged in a longitudinally movable manner in the pressure chamber 2 is a plunger-shaped nozzle needle 3, which has a guide section 5, by means of which it is guided in a guide region 6 of the pressure chamber 2. Here, the nozzle body 1 generally forms part of a fuel injector, which also has corresponding control devices to control the movement of the nozzle needle 3. In this case, the nozzle needle 3 has, at its end facing the combustion chamber, a sealing surface 7 which is of substantially conical design and which interacts with a nozzle seat 8 formed at the combustion-chamber end of the pressure chamber 2. At the combustion-chamber end, the pressure chamber 8 merges into a blind hole 10, from which one or more injection openings 11 start. The sealing surface 7 of the nozzle needle 3 and the nozzle seat 8 form a seal, which controls the flow of the fuel from the pressure chamber 2 into the blind hole 10 and, from there, into the injection openings 11. When the nozzle needle 3 is in contact with the nozzle seat 8, it cuts off a fuel flow between the pressure chamber 2 and the blind hole 10 and hence the injection openings 11. When the nozzle needle 3 rises from the nozzle seat 8 through a longitudinal movement, a through flow cross section between the sealing surface 7 and the nozzle seat 8 is opened, and fuel flows out of the pressure chamber 2, through this through flow cross section, into the blind hole 10 and is forced outward there through the injection opening 11. Owing to the high pressure in the pressure chamber 2, which can be over 2000 bar in the case of present-day conventional fuel injection nozzles, the fuel is finely atomized as it emerges from the injection openings 11, thus being prepared for combustion in a combustion chamber of an internal combustion engine.

The nozzle needle 3 is provided with a first electric contact 14, via which the nozzle needle 3 is connected to an electric voltage source 16. The nozzle body 1 is provided with a second electric contact 50, which is likewise connected to the voltage source 16, thus enabling an electric voltage U to be applied between the nozzle needle 3 and the nozzle body 1. In this case, the nozzle needle 3 is mounted in the nozzle body in such a way that, when the nozzle needle 3 rises from the nozzle seat 8, there is no electric contact between the nozzle needle 3 and the nozzle body 1. To measure the current I, a measuring device 18 is provided in the electric circuit between the nozzle needle 3 and the nozzle body 1, thus allowing the electrical transfer resistance R between the nozzle needle 3 and the nozzle body 1 to be calculated from the applied voltage and the current intensity in accordance with the known relationship R=U/I.

The sealing surface 7 of the nozzle needle 3 is coated with a “DLC layer” 20 (diamond-like carbon), i.e. a layer which is composed principally of carbon that is strongly bonded and, as a result, forms a very hard and hence wear-resistant layer. In this regard, FIG. 1a shows this layer 20 in an enlarged illustration of the detail, denoted by A, in FIG. 1, wherein the thickness of the layer 20 in this illustration is greatly exaggerated. Normally, the actual thickness of the layer is less than 5 μm, preferably 1 to 2 μm.

Under normal conditions, this layer 20 has a relatively high electrical resistance R, and therefore no electric contact occurs between the nozzle needle 3 and the nozzle body 1 in the region of the nozzle seat 8 when the nozzle needle 3 is simply resting on the nozzle seat 8, and the transfer resistance R is correspondingly high. If the nozzle needle 3 is pressed into the nozzle seat 8 with a high force, however, the physical property of the DLC layer 20 changes in such a way that the resistance thereof falls very sharply, generally by several orders of magnitude, with the result that the DLC layer 20 becomes electrically conductive. As a result, the transfer resistance R between the nozzle needle 3 and the nozzle body 1 likewise falls by several orders of magnitude, and, when an electric voltage U is applied between the first electric contact 14 and the second electric contact 15, this is observable from a significant increase in current intensity I, which is equivalent to a sharp drop in electrical resistance R. It is thereby possible to measure the time at which the nozzle needle 3 is resting on the nozzle seat 8 with high precision, and it can be used as an input variable for the control of injection by a fuel injection nozzle, in which the movement of the nozzle needle 3 is effected by an electric actuator.

As already mentioned, except in the region of the nozzle seat 8, the nozzle needle 3 must be electrically insulated with respect to the nozzle body 1, especially also in the region of the guide section 5. However, since the guide section 5 is not subject to any pressure stress during the operation of the fuel injection valve, this region can be provided with a DLC layer 20, which has an electrically insulating effect in the absence of a corresponding mechanical load in this region. Thus, it is also possible to provide the entire nozzle needle 3 with a DLC layer 20, which has the desired wear-reducing effect but has an electrically insulating effect in the region in which only low mechanical stresses occur.

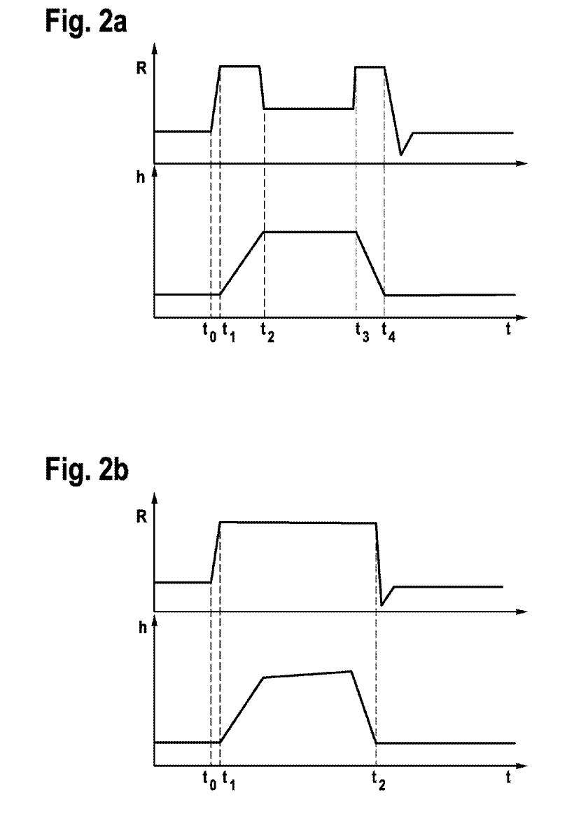

The time characteristic of the transfer resistance R and of the stroke h of the nozzle needle 3 is illustrated schematically in FIG. 2a. Before time t₀, the nozzle needle 3 is in its closed position in contact with the nozzle seat 8. The electrical transfer resistance R is low since the DLC layer is under a high load. At time t₀, the nozzle needle begins its opening movement, wherein the resistance R rises even before the nozzle needle rises from the nozzle seat 8 since the force on the DLC layer 20 decreases and ultimately assumes a constant and significantly higher value as soon as the nozzle needle 3 has risen from the nozzle seat 8. Here, the resistance R is finite since a slight current flow is still possible via the guide section 5. At time t₂, the nozzle needle 3 has reached its maximum opening stroke since it comes into contact with a stroke stop. Since there is a certain current flow via the stroke stop as well, the transfer resistance R falls again somewhat. At time t₃, the closing movement of the nozzle needle 3 starts, and the resistance rises again since the stroke stop is left behind. As soon as the nozzle needle is resting on the nozzle seat 8 at time t₄, the resistance falls sharply until the force on the nozzle needle and hence on the DLC layer 20 reaches a maximum. The slight overshoot in the resistance R is attributable to the impact momentum of the nozzle needle 3.

In FIG. 2b, the time characteristic of the needle stroke h and the resistance R are illustrated in the same way as in FIG. 2a, when the nozzle needle 3 does not have a maximum stroke limited by a mechanical stroke stop but is in “ballistic mode”. In this case, a closing force—produced hydraulically for example—is exerted on the nozzle needle before it is in a maximum opening position, and, as a result, the nozzle needle is decelerated and pushed back into its closed position. In this case, the resistance R remains at a continuously high level as soon as the nozzle needle 3 has risen from the valve seat 8.

The change in the resistance R due to the landing of the nozzle needle 3 on the valve seat 8 provides a very clear signal that can be evaluated well electronically since the resistance R generally changes by several orders of magnitude. To control a precise injection, it is very advantageous to know the actual movement of the nozzle needle since the control of the electric actuators which move the nozzle needle directly or indirectly does not allow any precise conclusions to be drawn about the movement of the nozzle needle. By means of these measured values, the time and duration of the injection can be corrected if necessary.

It is also possible to make provision only for the nozzle needle 3 to be provided with an electric contact 14 and for the nozzle body 1 to be grounded, i.e. connected to a ground connection 17. It is thus possible to measure the electric voltage U between the nozzle needle 3 and ground, which likewise gives an electric signal that can be evaluated, but, in this case, it is possible to dispense with a second electric contact 15, namely the electric contact of the nozzle body 1.

1. A fuel injection nozzle comprising a nozzle body (1), in which a pressure chamber (2) is formed, wherein the pressure chamber can be filled with fuel at high pressure and wherein a nozzle needle (3) is arranged in the pressure chamber in a longitudinally movable manner, a sealing surface (7) of said nozzle needle interacting with a nozzle seat (8) in order to open and close at least one injection opening (11), wherein the nozzle needle (3) has a guide section (5), of which the nozzle needle is guided in a radial direction in a guide region (6) of the pressure chamber (2), and wherein the nozzle needle (3) has a coating (20) at least in a region of the sealing surface (7), wherein the coating is a DLC layer (DLC=diamond-like carbon), characterized in that the nozzle needle (3) is electrically insulated with respect to the nozzle body (1) in an open position of said nozzle needle.

2. The fuel injection nozzle as claimed in claim 1, characterized in that electric contact can be made with the nozzle needle (3) and the nozzle body (1) and in that an electric voltage can be applied between the nozzle needle (3) and the nozzle body (1).

3. The fuel injection nozzle as claimed in claim 2, characterized in that the nozzle needle (3) is connected to a first electric contact (14), via which an electric voltage (U) can be applied to the nozzle needle (3).

4. The fuel injection nozzle as claimed in claim 3, characterized in that the nozzle body (1) is connected to a second electric contact (15), wherein an electric voltage (U) can be applied between the first electric contact (14) and the second electric contact (15).

5. The fuel injection nozzle as claimed in claim 4, characterized in that the nozzle body (1) is grounded.

6. The fuel injection nozzle as claimed in claim 1, characterized in that the guide section (5) of the nozzle needle (3) is also coated with a DLC layer (20).

7. The fuel injection nozzle as claimed in claim 1, characterized in that an entire surface of the nozzle needle (3) is coated with a DLC layer (20).

8. The fuel injection nozzle as claimed in claim 1, characterized in that the nozzle seat (8) is coated with a DLC layer (20).

9. A method for operating a fuel injection nozzle as claimed in claim 1, that the method comprising applying an electric voltage (U) between the nozzle needle (3) and the nozzle body (1), and simultaneously measuring the current intensity (I) of current flowing between the nozzle needle (3) and the nozzle body (1).

10. The method as claimed in claim 9, characterized in that electrical resistance (R) between the nozzle needle (3) and the nozzle body (1) is determined from the voltage (U) and the current intensity (I).

11. The method as claimed in claim 10, characterized in that a change in the electrical resistance (R) is used as an input variable for control of fuel injection.
